(19) United States
(12) Patent Application Publication
(10) Pub. No.: US 2004/0118257 A1
(43) Pub. Date: Jun. 24, 2004

(54) Motor-driven cutting device

(75) Inventor: Erich Kratzmaier, Eurasburg - Beuerberg (DE)

Correspondence Address: WOOD, PHILLIPS, KATZ, CLARK & MORTIMER, 500 W. MADISON STREET, SUITE 3800, CHICAGO, IL, 60661, US

(73) Assignee: Kratzmaier Konstructionen GmbH

(21) Appl. No.: 10/733,736

(22) Filed: Dec. 11, 2003

(30) Foreign Application Priority Data
Dec. 16, 2002 (EP) 02 028 241.4

(51) Int. Cl. B26D 1/00; B26B 13/00

(52) U.S. Cl. 83/13; 30/265

(57) ABSTRACT

The invention refers to a novel device for cutting flat objects, in particular for cutting stiff bandages and protective suits. The device provides at least one movable cutting tool (8, 13), which is able to perform a movement, that can be assigned to a closed line surrounding a finite area.

### TECHNICAL FIELD

This invention refers to a motor-driven cutting device for cutting flat objects. The device is intended to be employed as a hand-held apparatus, i.e. it should be possible to hold it—as a complete apparatus—with one or both hands. The invention is preferably directed to devices, which are designed for cutting open flat objects surrounding the human body, in particular stiff bandages, protective clothing like motorcyclist suits etc. It is however also directed to hand-held cutting devices for cutting open flat objects of other kind.

### PRIOR ART

In particular when cutting open bandages and especially stiff bandages, one encounters major problems when using purely hand-operated scissors and other tools. Common bandages are already rather difficult to be cut open by means of scissors and furthermore bear a certain risk of inflicting injuries to the patient in consequence of the applied physical forces. These problems especially and in a pronounced manner apply to the opening of stiff bandages made of plaster or plastics.

Similar problems however e.g. also arise when opening the protective suit of a motorcyclist during first aid at the accident place. There, a rescue medic or a physician has to diagnose injuries and to make accessible bodily parts the quickest possible by applying simple means. The protective biker suit—with respect to potential bone injuries, in particular vertebral fractures—cannot be taken off in a conventional way. Under these circumstances, it would be very advantageous for the efficiency of diagnosis and medical support to be able to quickly cut open a protective suit by simple means. This in an analogous manner is also valid for other situations, e.g. in case of an accident, in which the protective suit of an injured person has to be cut open.

### OBJECT OF THE INVENTION

The invention is thus based on the technical problem to provide a favourable cutting device for flat objects.

### SUMMARY OF THE INVENTION

DE 719 969 shows a device for cutting flat objects. U.S. Pat. No. 4,682,416 furthermore shows a device for cutting thin sheet metals, which is similar to a pair of scissors and is driven by a hand drill. The same applies to U.S. Pat. No. 3,025,599.

The invention on the one hand is directed to a device for cutting flat objects, wherein this device can be held with the hands and is provided with a driving motor unit and a cutting tool unit, which at least comprises one cutting tool being movable and drivable by the driving motor unit and at least one further cutting tool, wherein the movable cutting tool is movable relatively to the further cutting tool, and wherein the movement of a cutting edge of the moveable cutting tool corresponds to a closed pathway surrounding a finite area, characterized in that the at least one movable cutting tool is held rotatably and displaceably at a bearing axis distant from the cutting edge of said movable cutting tool and that said movable cutting tool is also held at an eccentric located closer to said cutting edge and allowing to drive said movable cutting tool.

The invention furthermore is also directed to a corresponding method, in which the device is held with the hand and is guided with its cutting tool unit along the flat object, whereby the cutting tool unit cuts open the flat object under the actuation of the driving motor unit.

Finally, the invention also is directed to a cutting device, which can be coupled to a conventional electrical screwing machine or drilling machine, like e.g. a storage battery driven screw driver or a hand drill with a power cable, in order to provide the motor-driven cutting device according to the invention.

Favourable embodiments are indicated in the dependent claims and are explained in detail in the following description, wherein the respective characteristics are to be understood in respect to the method aspect as well as in respect to the device aspect of the invention.

The device according to the invention thus possesses a cutting tool unit with at least two cutting tools in addition to the driving motor unit. Of these cutting tools, at least one is drivable by the driving motor unit, and, in its actuated state, moves relatively to the other cutting tool. Thus, there can be realised e.g. a movable cutting tool and a cutting tool, which is static in relation to the driving motor unit, or, alternatively, two cutting tools, which are movable relatively to each other and to the driving motor unit. In particular, these cutting tools can be realised as knife-like tools. The cutting process itself can be accomplished by the sharpness of one cutting edge in a knife-like manner or by a cutting between two edges of the at least two cutting tools in a manner similar to a pair of scissors. Possible of course are also mixed forms of the cutting process. During the cutting process, relative movement is realised between the flat object and the cutting tools vertical to the flat object's plane and also in this plane. For the invention, the kind of movement of the movable cutting tool relative to the other cutting tool has certain relevance. This movement should not be realised as a simple back and forth movement along a single line, but should correspond to a closed pathway surrounding a finite area. If one thus imagines a point at the cutting edge of the movable cutting tool and follows this point during the movement relative to the other cutting tool, there finally results a closed line. This line should surround an area, thus not being the result of a linear bidirectional movement. This area can be roundish, but has not necessarily to be circular. It may e.g. be elliptical or may have another roundish two-dimensional form.

According to the inventor's observation, this results in a favourable coupling of different components of movement between the cutting tools and the flat object to be cut. Particularly present therein are movement components, which are vertical to the flat object's plane, or movement components within this plane, wherein these components allow for a favourable cutting result. The preceding description applies both to the relative movements between a moveable cutting tool and a further, static cutting tool, and to the relative movements between two movable cutting tools.

The movement according to the invention is created in that the cutting tool(s) on the one hand is/are held rotatably and displaceably along a guide pin or—in a more general wording—along a guide axis, wherein this mounting is realised in an area distant from the cutting edge, and in that the cutting tool(s) on the other hand is/are driven by an eccentric, wherein this actuation is realised at a position significantly closer to said cutting edge. By combining the arrangement at the eccentric and the distantly located, rotatable and displaceable mounting, the described movement type at the cutting edge is realised. In this context we also point to the example.

In one embodiment, the driving motor unit is detachably connected to the cutting tool unit, i.e. the cutting tool unit can be removed from the remaining device. The term “detachable” therein of course does not mean a complete disassembly of the device and a subsequent separation of the respective elements, but a removal being possible without using tools or by using just simple tools without being obliged to disassemble the separated units into their individual components and preferably without being obliged to open the respective housing. What is meant is e.g. the release of one or a few fastening screws and a subsequent detachment. Thereby, the cutting tool unit can be easily cleansed or—in case of using it for medical applications—also be sterilised. In particular, when applying cleansing and sterilising processes, one is no more obliged to take special care of the driving motor unit, which may e.g. be significantly more sensitive to a thermal sterilisation. One may also provide several cutting tool modules, so that one can easily interchange differently designed variants for different applications or can easily replace a blunt or dirty cutting tool module by another module.

Preferably, not only the cutting tool unit is detachable from the driving motor unit in the described manner, but also a gear unit provided between cutting tool unit and driving motor unit is accordingly detachable from the cutting tool unit on the one hand and from the driving motor unit on the other hand. Firstly, the described advantages thus also become possible for the gear unit. Secondly, one is allowed to employ different gear units with different transmission ratios or different angles but also with different length between the driving motor unit and the cutting tool unit.

A further embodiment provides a ball bearing in the cutting tool unit, by means of with which the at least one movable cutting tool is held. It has been observed, that in rigorous use of a device according to the invention, increased temperatures may arise due to friction losses in the cutting tool unit. These increased temperatures should be avoided either with respect to the danger of injury for a patient or victim of an accident or with respect to the material to be cut. Thereby, it has proven to be very advantageous to realise the described movement of the moveable cutting tool in a way having reduced friction by using at least one ball bearing. The ball bearing is used for the arrangement of the cutting tool at the eccentric. For further detail, we refer to the exemplary embodiment.

A further aspect of the invention relates to a favourable detection of temperature in the cutting tool unit. Thus, a danger for a human or the material to be cut or for the device itself can be avoided by detecting a typical temperature near the cutting tools and by a corresponding reaction of the device, e.g. a warning signal or a safety disconnecting switch. This temperature detection can be realised in addition to or as an alternative to the mentioned ball bearing. Particularly suitable are thermo elements.

The cutting tools themselves preferably are mainly plain and are sliding along each other with their surfaces during their relative movement. They may provide a convex cutting edge, which either allows for a shearing effect or a knife-like effect on the material to be cut. The cutting edge in particular may also be provided with teeth in order to engage with the object to be cut especially effective. These teeth in particular may also be present at just one cutting edge, e.g. at the cutting edge of the movable cutting tool.

According to a further advantageous embodiment of the invention, a significant friction is allowed to occur between a cutting edge of a movable cutting tool and the flat object to be cut, especially in consequence of the mentioned teeth, so that the device with its cutting tools—in consequence of the movement components comprising one component in the flat object's plane—travels through the object along a cutting line. The cutting tool movement according to the invention can thus —besides improved cutting results—also offer a simplification of guidance of the device by an operating person, wherein this person is no more obliged to use physical effort to produce a sufficient pressure in order to properly convey the cutting tool along the bandage or the suit or another object.

In a preferred embodiment, the cutting tool unit according to the invention is equipped both with two movable cutting tools and a further, static cutting tool, which is located between these movable cutting tools. Thus, a cutting process is realised on both sides of the static cutting tool, allowing the machine to work with a particular efficiency. In case of using dephased movement of the two movable cutting tools, a mass balance can be achieved, if desired. Moreover, by using the two movable cutting tools flanking the static cutting tool having a certain width, it is possible, not just to generate a linear cut in the flat object, but to cut out a strip from the flat object. This can facilitate the subsequent opening of a stiff bandage or a protective suit.

The driving motor unit preferably allows for a continuous regulation of the motor speed and thus of the cutting tool movements. In particular, the driving motor unit can provide a button for switching on and, resulting from a release of the button, for switching off said driving motor unit, wherein the intensity of pressure exerted on the button, or the depth, by which the button is pushed into a guideway, can serve to adjust the driving speed.

A further aspect of the invention refers to the feature that the driving motor unit can be chosen from a type already commercially available, especially as a common hand drill or as an electric screw driver with a storage battery supply or a power supply cord. A device of this kind without the corresponding chuck for the attachment to drilling machines or screwing bits can e.g. be employed. A gear of the device according to the invention can then be mounted onto the driven shaft of these machines, wherein said driven shaft is normally equipped with a corresponding thread. For this aim, one can previously attach e.g. a gearwheel to the driven shaft. The invention thus also refers to a cutting device designed according to the previously described principles, but lacking the driving motor unit, wherein this device is designed to be connected to such conventional driving motor units.

The device according to the invention can thus in particular be comprised of three modules, namely firstly of a modular detachable cutting tool unit, secondly of a modular intermediate gear unit and thirdly of a conventional drilling or screwing machine as a driving motor unit.

In the following, the invention is further explained by means of an exemplary embodiment, which is depicted in the appended figures. Individual characteristics disclosed in this context can also be relevant for the invention when being realised in alternative combinations.

### BRIEF DESCRIPTION OF THE DRAWINGS

FIG. 1 shows a perspective view of a device according to the invention.

FIG. 2 shows the device from FIG. 1 with the cutting tool unit being detached.

FIG. 3 shows an explosion view of the cutting tool unit from FIG. 2.

FIG. 4 shows a view of the device from FIGS. 1 and 2 in a divergent perspective and with the cutting tool unit being detached, wherein the gear unit is shown in a partly disassembled state.

### PREFERRED EMBODIMENT

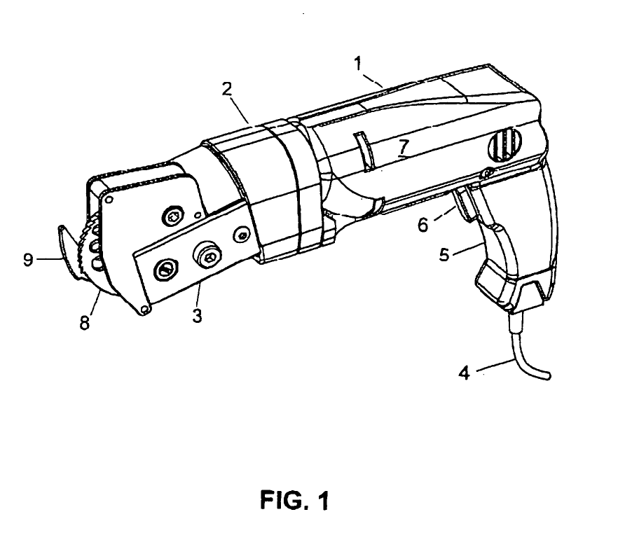

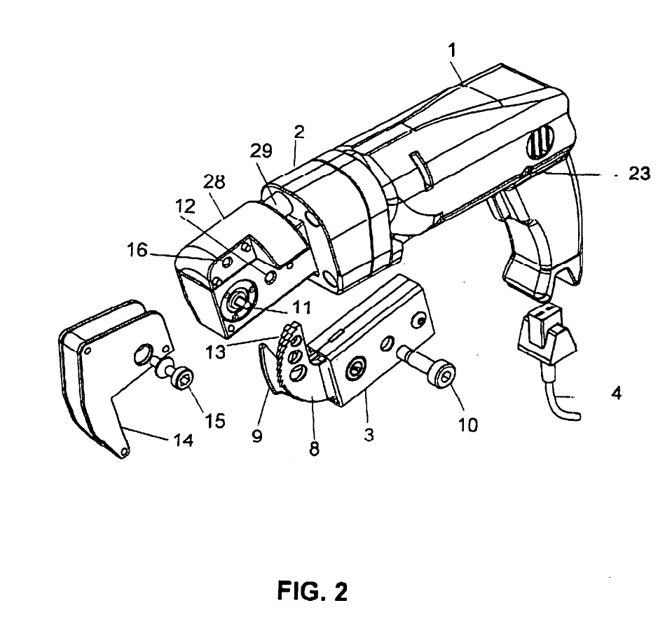

In FIG. 1 one envisages a cutting device according to the invention, comprising a driving motor unit 1, a gear unit 2 and a cutting tool unit 3. Driving motor unit 1 here is a conventional electrical drilling machine with a power cable 4, an operating handle 5, a button 6 for switching on and controlling speed and, finally, with an electrical motor not being visible in FIG. 1, but being located in a housing part indicated by numeral 7. A gear unit 2 is attached at the side of driving motor unit 1 being depicted in the left front part in FIG. 1, wherein this gear unit in particular contains a gear reduction for increasing the torque and reducing the rotational speed and for reversing the rotational direction by 90°. A driven shaft of driving motor unit 1 (see 11 in FIG. 2)—as it is typical for such drilling machines—is positioned along the longitudinal axis of the total device shown in FIG. 1. The rotation axis of the driven shaft (not depicted in FIG. 1) of gear unit 2 (see FIG. 2) however is vertical to this and extends in the horizontal direction (when handle 5 is orientated downwardly).

Cutting tool unit 3 being coupled to gear unit 2 provides three cutting tools, of which a movable cutting tool 8 and a static cutting tool 9 are visible in FIG. 1.

FIG. 2 shows the device from FIG. 1, wherein cutting tool unit 3 has been detached from the gear unit 2 after having released an inbus (hexagon socket) fastening screw 10. One further envisages the previously mentioned driven shaft of gear unit 2, which is indicated by numeral 11, and a neighbouring threaded pocket hole 12 for fastening screw 10. The coupling between cutting tool unit 3 and gear unit 2 is further stabilised by (not depicted) anti-twist pins and recesses, so that driven shaft 11 and the corresponding coupling module of cutting tool unit 3 are not stressed when fastening screw 10.

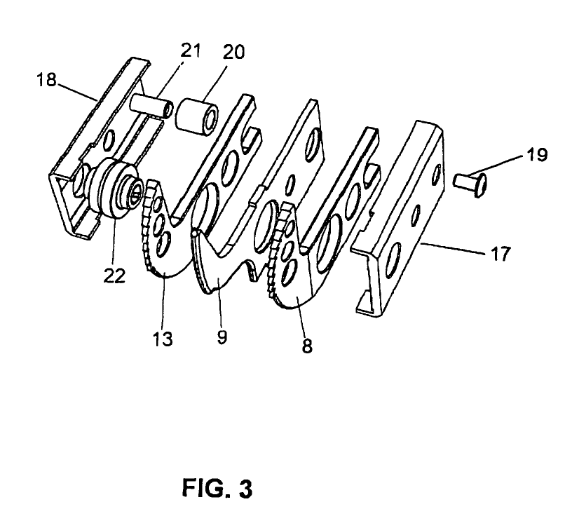

FIG. 2 furthermore shows a second movable cutting tool 13, which is described in more detail in FIG. 3. The figures moreover show, that movable cutting tools 8 and 13 exhibit roughly semicircular convex cutting edges provided with teeth at the side opposed to the driving motor unit 1, whereas static cutting tool 9 here possesses a less curved, but slightly convex sliding edge without any teeth.

FIG. 2 finally shows a protective cap 14, which can be attached by a fastening screw 15 in a threaded pocket hole 16 of gear unit 2. This protective cap 14 is not essential for the invention's function, but it reduces the danger of accidental injuries, in particular at the fingers of the operating person. To this aim, it largely covers cutting tools 8, 9 and 13 during operation and is pushed up mainly in direction to driving motor unit 1 by a flat object to be cut, when cutting tools 8, 9 and 13 are approached. To this aim, a part 28 of gear unit 2, to which protective cap 14 can be fastened, is realised in a displaceable form, wherein this displacement is enabled via a guiding element 29 along the longitudinal axis of the device.

In contrast to FIG. 1, cable 4 is removed from driving motor unit 1 in FIG. 2.

FIG. 3 is an explosion view and only shows cutting tool unit 3 from FIGS. 1 and 2. This view, besides already mentioned cutting tools 8, 9 and 13, particularly shows two housing jacket parts 17 and 18. A fastening screw 19 keeps together these two housing jacket parts 17 and 18 in the assembled state. This fastening screw therein penetrates both recesses at movable cutting tools 8 and 13 opening at the side orientated towards the driving motor unit 1 and a boring in static cutting tool 9. A slide bushing 20 is provided, which is arranged between the recesses and the boring on the one hand and a reception pivot 21 being designed for fastening screw 19 and belonging to housing jacket part 18 on the other hand. In consequence of the recesses being open on one side, movable cutting tools 8 and 13 are thus mounted on slide bushing 20 in a slidingly rotatable and displaceable manner.

Cutting tools 8, 9 and 13 moreover exhibit orifices for fastening screw 10 depicted in FIG. 2, wherein these orifices in case of movable cutting tools 8 and 13 provide a play considering the cutting tools' movement. Finally, cutting tools 8, 9 and 13 each provide a rather big circular boring, which in the mounted state is occupied by an eccentric 22. Eccentric 22 in the regions of its largest diameter provides two ball bearings being axially juxtaposed and a further ball bearing on each side in the two outer regions having a smaller diameter and axially flanking these inner elements. The two external, smaller ball bearings in the mounted state occupy the corresponding borings of housing jacket parts 17 and 18 shown in FIG. 3, so that eccentric 22 is rotatable against these housing jacket parts 17 and 18 without producing a sliding friction. The same in parallel applies to the larger, axial interior ball bearings occupying the orifices in movable cutting tools 8 and 13. Between the movable cutting tools, there is a gap for static cutting tool 9 (see FIG. 3). Accordingly, when a driving shaft inside the ball bearings of eccentric 22 is actuated in a rotating manner by driven shaft 11 of gear unit 2 (depicted in FIG. 2), a rolling friction in the respective ball bearings in each case is produced between this driving shaft, housing jacket parts 17 and 18 and movable cutting tools 8 and 13, whereas static cutting tool 9 is free from the eccentric.

The eccentric movement of eccentric 22 only affects the two larger ball bearings located at the interior of the axis and accordingly is translated into oval rotating movements of the cutting edges of movable cutting tools 8 and 13, which thereby are twisted back and forth around slide bushing 20 and are somewhat displaced along said bushing 20. The eccentricity of the two larger ball bearings of eccentric 22 thereby is dephased by 1800, such that two cutting tools 8 and 13 are moved in a correspondingly dephased manner.

During operation, the device is applied at the edge of e.g. a stiff bandage, wherein static cutting tool 9 (see FIG. 1) is put on underneath of said stiff bandage and a driving motion of movable cutting tools 8 and 13 is caused by tapping button 6. The movable cutting tools move in a counterclockwise manner (according to FIGS. 1 and 2) and—during this rotating movement—are on the one hand again and again pressed onto the stiff bandage being grasped by cutting tool 9. On the other hand, they are—after having accomplished half of this downward movement (i.e. a left hand movement according to FIG. 1)—practically moved backwardly (i.e. downwardly according to FIG. 1), so that a forward movement of the device is produced relatively to the stiff bandage. During operation, the longitudinal axis of the device from FIG. 1 (the rotational axis of the driving axle of driving motor unit 1) thus is approximately vertical to the flat object to be cut, in particular to a stiff bandage. Both movable cutting tools 8 and 13 are practically travelling along on the bandage, thereby cutting it open during their “downwardly stepping” movement, wherein static cutting tool 9 is used as a thrust bearing. In this case, a process is realised, which partly is like a kind of sawing process due to the teeth provided at movable cutting tools 8 and 13 (see respective figures) and—at the other part—is a shearing process between movable cutting tools 8 and 13 and static cutting tool 9. During operation, movable cutting tools 8 and 13 with their toothed cutting edges do not have to be moved beyond the outer edges of static cutting tool 9, so that no risk of inflicting injuries is given when moving along the device on the skin of a patient or a victim of an accident.

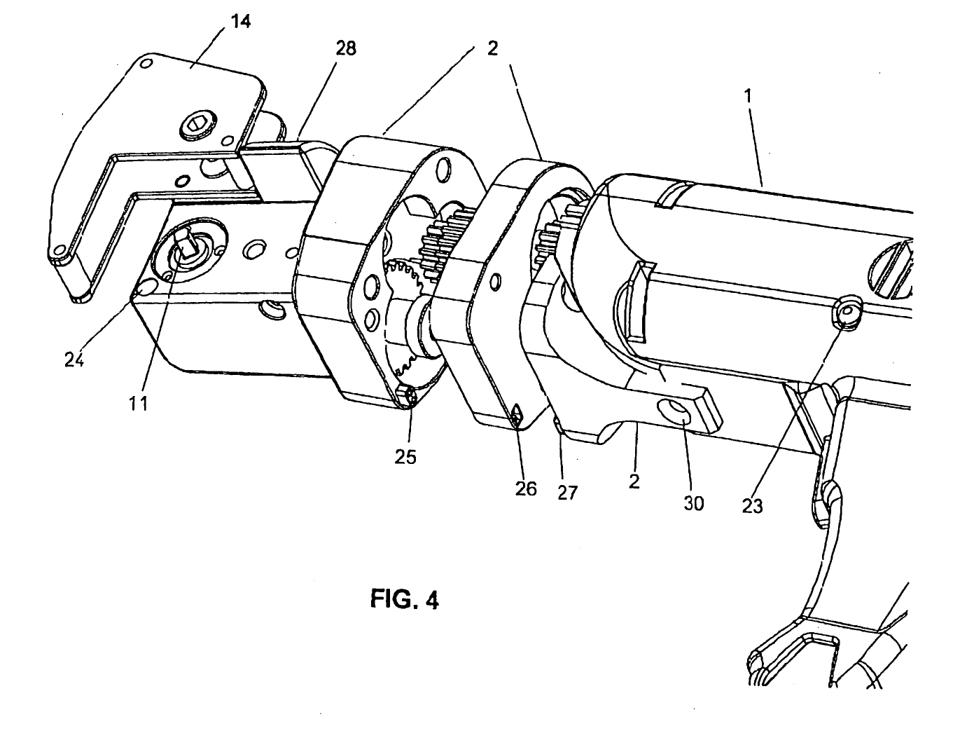

At the side orientated towards cutting tool unit 3, gear unit 2 further provides a thermo element sensor (see number 24 in FIG. 4), which—via an electrical coupling between gear unit 2 and driving motor unit 1—transmits a voltage signal and is coupled to a LED-display 23. In case of a thermal overload of cutting tool unit 3, LED-display 23 produces a flash signal in order to warn the user in due time.

In consequence of employing the ball bearings of eccentric 22, the friction losses in cutting tool unit 3 are anyhow limited, so that a thermal overload in comparison to sliding friction losses will occur at a later stage. The sliding friction heat produced between movable cutting tools 8 and 13 and slide bushing 20 has proven to be rather unimportant. It is understood, that ball bearings could also be employed at this site. In case of providing a lateral space between the bars (“U-legs”) flanking the unilaterally open recesses of the cutting tools 8 and 13, each of these bars could be connected with a ball bearing, thereby again limiting the friction to rolling friction.

FIG. 4 shows the device from FIGS. 1 and 2 with driving motor unit 1, gear unit 2 and protective cap 14, but without cutting tool unit 3. What is to be seen is at first thermo element sensor 24, which has already been described and which is located in vicinity to driven shaft 11 of gear unit 2. It can thus detect the temperature of cutting tool unit 3 in a region relatively close to the cutting edges. Since cutting tool unit 3 is made of metal, sufficiently exact information is also provided for the temperature in cutting tool unit 3.

This thermo element sensor 24 in the end is connected to already mentioned LED-display 23 or to the corresponding control electronics via non-depicted wirings, a plug connection element 25, an electrical connection element 26, a further plug connection element 27, and a non-depicted electrical plug connection between gear unit 2 and driving motor unit 1. Plug connection elements 25 and 27 and electrical connection 26 serve to realise the gear unit 2 in a disassemblable form in order to allow further application of lubricants, cleansing or repair, like it is depicted in FIG. 4 by the representation of the partly disassembled state. Here, one can in particular see the different gearwheels of a gear reduction. In the mainly cuboid housing jacket part of gear unit 2, in neighbourhood to driven shaft 11, two bevelled gear rims, which have rotational axes vertical to each other, and of which one gear rim is mounted on driven shaft 11, engage with each other. Thus, the rotating motion produced by the electrical motor in driving motor unit 1 can be reduced via gear unit 2 and—after being dephased by 90° in the rotational axis—be transferred to cutting tool unit 3.

FIG. 4 by reference numeral 30 depicts a boring in a protruding part of gear unit 2, wherein this part reaches out under the housing of driving motor unit 1. Via this boring 30, gear unit 2, otherwise only put upon the driven shaft of driving motor unit 1, can be fastened to driving motor unit 1. In a converse manner, one just has to release the fastening screw fixed at boring 30 in order to detach gear unit 2 as a module from driving motor unit 1. During this disassembly, it remains a complete block comprised of the interconnected parts shown in FIG. 4. For a disassembly according to FIG. 4, further fastening screws interconnecting the different parts thus have to be released. In particular, one can detach the two elements of gear unit 2, which in FIG. 4 are in vicinity to driving motor unit 1 (namely those elements comprising electrical connection parts 26 and 27) by releasing some fastening screws and can replace them with elements being adapted to other types of the driving motor unit 1. This however, is generally not necessary for the user.

1. A device for cutting flat objects,
which can be held with the hands and is provided with:
a driving motor unit (1) and a cutting tool unit (3), which at least comprises one cutting tool (8, 13) being movable and drivable by said driving motor unit (1), and at least one further cutting tool (13, 9),
wherein said movable cutting tool (8, 13) is movable relatively to said further cutting tool (13, 9), wherein the movement of a cutting edge of said movable cutting tool (8, 13) corresponds to (belongs to) a closed pathway surrounding a finite area;
wherein said at least one movable cutting tool (8, 13) is held rotatably and displaceably at a bearing axis (20, 21) distant from the cutting edge of said movable cutting tool, and wherein said movable cutting tool is also held at an eccentric (22) located closer to said cutting edge and allowing to drive said movable cutting tool.

2. A device according to claim 1, in which said cutting tool unit (3) is detachable from said driving motor unit (1).

3. A device according to claim 2, comprising a gear unit (2), via which said driving motor unit (1) can actuate said cutting tool unit (3), wherein said gear unit (2) is detachable from said driving motor unit (1) and from said cutting tool unit (3).

4. A device according to claim 1, in which said movable cutting tool (8, 13) in said cutting tool unit (3) is held by means of a ball bearing (22).

5. A device according to claim 1, comprising a temperature detection device (24) for detecting a temperature in said cutting tool unit (3).

6. A device according to claim 1, in which said cutting tools (8, 9, 13) are plain and slide along each other with their surfaces.

7. A device according to claim 6, in which at least said movable cutting tool (8, 13) has a convexly curved cutting edge, which preferably is provided with teeth.

8. A device according to claim 1, in which said cutting tool unit (3) during operation is transported along said flat object to be cut in consequence of friction between a cutting edge of said at least one movable cutting tool (8, 13) and said flat object.

9. A device according to claim 1, comprising two movable cutting tools (8, 13) and a static cutting tool (9) being arranged between said movable cutting tools (8, 13), wherein the device during the cutting process slidingly engages with the bottom side of said flat object or is slidingly supported thereupon via its static cutting tool (9).

10. A device according to claim 1, in which said driving motor unit (1) allows for a continuous regulation of velocity by the operator.

11. A device for cutting flat objects, comprising a cutting tool unit (3) and a gear unit (2), wherein this device is designed to form a device according to claim 1 by coupling said gear unit (2) to a common electrical drilling machine/screwing machine (1) serving as a driving unit (1).

12. A method for cutting flat objects by means of a device being provided with:
a driving motor unit (1) and a cutting tool unit (3), which at least comprises one cutting tool (8, 13) being movable and drivable by said driving motor unit (1), and at least one further cutting tool (13, 9),
wherein said movable cutting tool (8, 13) is movable relatively to said further cutting tool (13, 9), wherein the movement of a cutting edge of said movable cutting tool (8, 13) corresponds to (belongs to) a closed pathway surrounding a finite area;
wherein said at least one movable cutting tool (8, 13) is held rotatably and displaceably at a bearing axis (20, 21) distant from the cutting edge of said movable cutting tool, and wherein said movable cutting tool is also held at an eccentric (22) located closer to said cutting edge and allowing to drive said movable cutting tool,
in which method the device is held with the hand and its cutting tool unit (3) is approached to said flat object, wherein said cutting tool unit (3) cuts open said flat object under the actuation by the driving motor unit (1).

13. A method according to claim 12, in which stiff bandages are cut open.

14. A method according to claim 12, in which protective suits, in particular motorcyclist suits, are cut open.
